(19) United States
(12) Patent Application Publication
(10) Pub. No.: US 2022/0304896 A1
(43) Pub. Date: Sep. 29, 2022

(54) MEDICINE SUPPLY DEVICE

(71) Applicant: Takazono Corporation, Kadoma-shi, Osaka (JP)

(72) Inventor: Yuichiro Sugimoto, Hirakata-shi, Osaka (JP)

(73) Assignee: Takazono Corporation, Kadoma-shi, Osaka (JP)

(21) Appl. No.: 17/635,425

(22) PCT Filed: Jun. 23, 2020
(86) PCT No.: PCT/JP2020/024624

§ 371 Date: Feb. 15, 2022

(30) Foreign Application Priority Data
Aug. 30, 2019 (JP) 2019-158827

(51) Int. Cl. A61J 7/00; B65G 47/14

(52) U.S. Cl. CPC A61J 7/0076; B65G 47/1457

(57) ABSTRACT

Each of a plurality of first protrusions is formed to be capable of, upon rotation of a rotor, pressing a medicine contained in a gap and conveying the medicine to a discharge port. Each of at least two second protrusions is formed to be capable of, upon rotation of the rotor, pressing a medicine located on a partitioning portion and moving the medicine from over the partitioning portion. Each of the at least two second protrusions has, on one side in a circumferential direction of the rotor, a one-side upper surface inclined downward to one side in the circumferential direction of the rotor.

### TECHNICAL FIELD

The present invention relates to a medicine supply device.

### BACKGROUND ART

Japanese Patent Laying-Open No. 2014-144207 (PTL 1) is a prior art document that discloses a configuration of a medicine supply device. The medicine supply device described in PTL 1 includes a containing portion, a rotor, and a partitioning member. Block portions are provided on a side surface portion of the rotor and spaced from each other, and gaps between the block portions form medicine containing grooves. As the rotor rotates, part of the rotor contacts part of the partitioning member, to provide movement to the partitioning member and move a medicine on the partitioning member.

### CITATION LIST

### Patent Literature

PTL 1: Japanese Patent Laying-Open No. 2014-144207

### SUMMARY OF INVENTION

### Technical Problem

In the medicine supply device described in PTL 1, the rotor may stop when medicines get stuck between a portion of a circumferential surface of the rotor that is above a block portion and an inner surface of the containing portion.

The present invention has been made in view of the aforementioned problem, and an object of the present invention is to provide a medicine supply device capable of preventing the occurrence of remaining medicines in a medicine containing portion, and suppressing sticking of medicines in the medicine containing portion.

### Solution to Problem

A medicine supply device based on a first aspect of the present invention includes a medicine containing portion, a rotor, a plurality of first protrusions, at least two second protrusions, and a partitioning portion. The medicine containing portion has a circumferential wall and a discharge port, and contains a medicine on an inner side of the circumferential wall and discharges the medicine through the discharge port. The rotor is rotatably disposed on the inner side of the circumferential wall, and has an upwardly convexly inclined top surface and a circumferential surface adjacent to the top surface. The plurality of first protrusions are provided on the circumferential surface and positioned with a gap between them in a circumferential direction of the rotor. The at least two second protrusions are provided on the circumferential surface, each of the at least two second protrusions being disposed above each of at least two first protrusions of the plurality of first protrusions. The partitioning portion is provided to extend from an inner surface of the circumferential wall toward the circumferential surface so as to partition between the at least two first protrusions and the at least two second protrusions above the discharge port. Each of the plurality of first protrusions is formed to be capable of, upon rotation of the rotor, pressing a medicine contained in the gap and conveying the medicine to the discharge port. Each of the at least two second protrusions is formed to be capable of, upon rotation of the rotor, pressing a medicine located on the partitioning portion and moving the medicine from over the partitioning portion. Each of the at least two second protrusions has, on one side in the circumferential direction, a one-side upper surface inclined downward to one side in the circumferential direction.

In one embodiment of the present invention, each of the at least two second protrusions further has, on the other side in the circumferential direction, an other-side upper surface inclined downward to the other side in the circumferential direction.

In one embodiment of the present invention, in each of the at least two second protrusions, an upper surface including the one-side upper surface and the other-side upper surface is inclined downward toward its tip end in a radial direction of the circumferential surface.

In one embodiment of the present invention, in the circumferential direction, an overall length of each of the at least two second protrusions is shorter than an overall length of each of the at least two first protrusions.

In one embodiment of the present invention, the partitioning portion is formed of a flexible member.

A medicine supply device based on a second aspect of the present invention includes a medicine containing portion, a rotor, a plurality of first protrusions, one second protrusion, and a partitioning portion. The medicine containing portion has a circumferential wall and a discharge port, and contains a medicine on an inner side of the circumferential wall and discharges the medicine through the discharge port. The rotor is rotatably disposed on the inner side of the circumferential wall, and has an upwardly convexly inclined top surface and a circumferential surface adjacent to the top surface. The plurality of first protrusions are provided on the circumferential surface and positioned with a gap between them in a circumferential direction of the rotor. The one second protrusion is provided on the circumferential surface and disposed above one first protrusion of the plurality of first protrusions. The partitioning portion is provided to extend from an inner surface of the circumferential wall toward the circumferential surface so as to partition between the one first protrusion and the one second protrusion above the discharge port. Each of the plurality of first protrusions is formed to be capable of, upon rotation of the rotor, pressing a medicine contained in the gap and conveying the medicine to the discharge port. The one second protrusion is formed to be capable of, upon rotation of the rotor, pressing a medicine located on the partitioning portion and moving the medicine from over the partitioning portion. The one second protrusion has, on one side in the circumferential direction, a one-side upper surface inclined downward to one side in the circumferential direction.

### Advantageous Effects of Invention

According to the present invention, the occurrence of remaining medicines in the medicine containing portion can be prevented, and sticking of medicines in the medicine containing portion can be suppressed.

### BRIEF DESCRIPTION OF DRAWINGS

FIG. 1 is a perspective view showing a medicine supply device with an open lid according to a first embodiment of the present invention.

FIG. 2 is a plan view of the medicine supply device in FIG. 1 as seen in a direction of an arrow II.

FIG. 3 is a bottom view of the medicine supply device in FIG. 1 as seen in a direction of an arrow III.

FIG. 4 is a perspective view showing the medicine supply device according to the first embodiment of the present invention, where a medicine containing portion is partially cut away.

FIG. 5 is a perspective view showing the medicine supply device according to the first embodiment of the present invention, where a rotor is shown in see-through.

FIG. 6 is a perspective view showing an outer appearance of the rotor of the medicine supply device according to the first embodiment of the present invention.

FIG. 7 is a side view showing a positional relationship between the rotor and a partitioning portion of the medicine supply device according to the first embodiment of the present invention.

FIG. 8 is a plan view showing a state where sticking of medicines has occurred in the medicine containing portion.

FIG. 9 is a perspective view showing an outer appearance of a rotor of a medicine supply device according to a second embodiment of the present invention.

FIG. 10 is a perspective view showing an outer appearance of a rotor of a medicine supply device according to a third embodiment of the present invention.

### DESCRIPTION OF EMBODIMENTS

A medicine supply device according to each embodiment of the present invention will be described hereinafter with reference to the drawings. In the following description of the embodiments, the same or corresponding portions in the drawings are denoted by the same reference characters and description thereof will not be repeated.

### First Embodiment

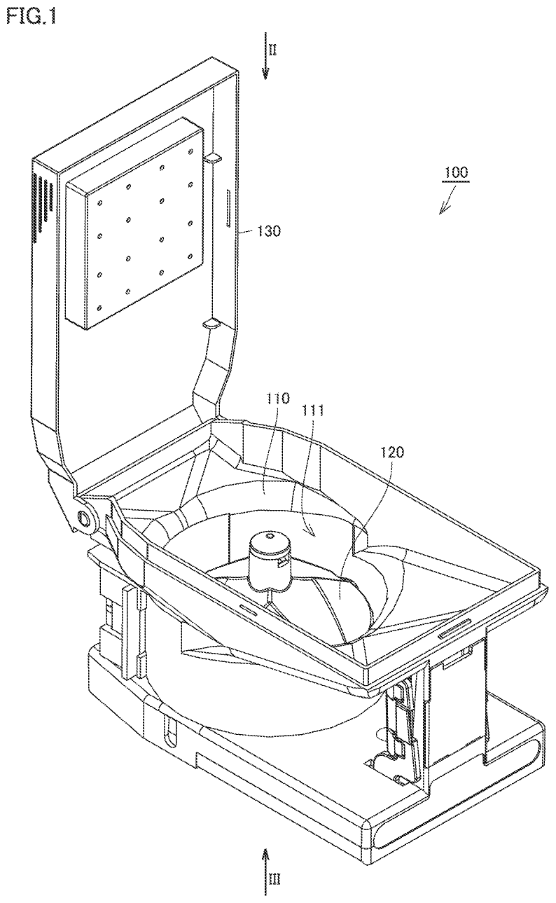

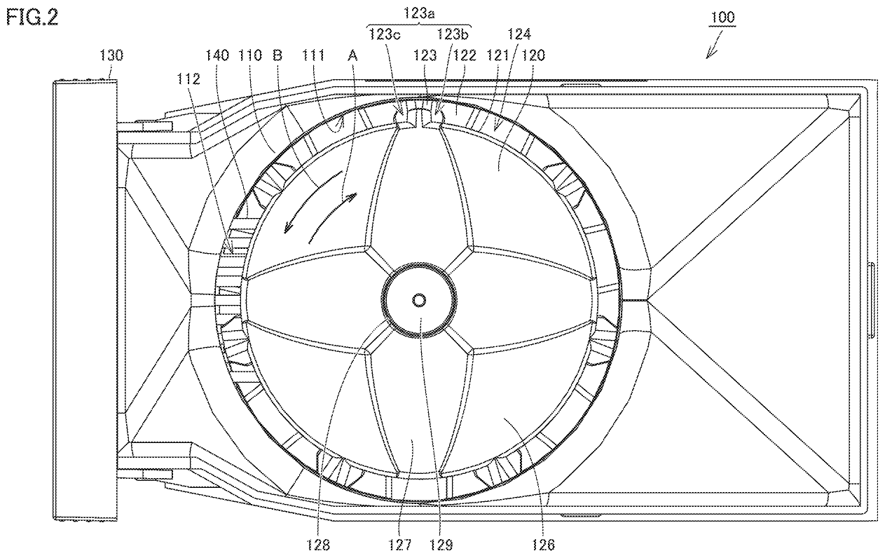

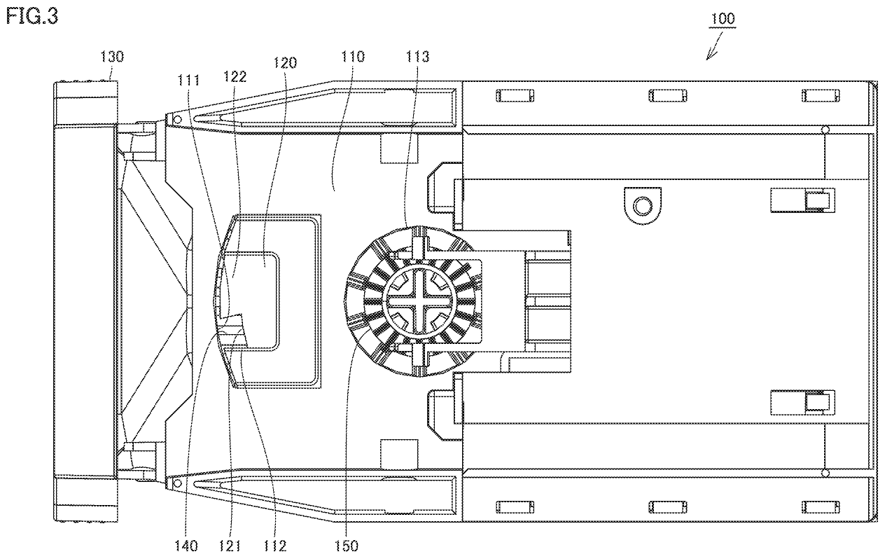

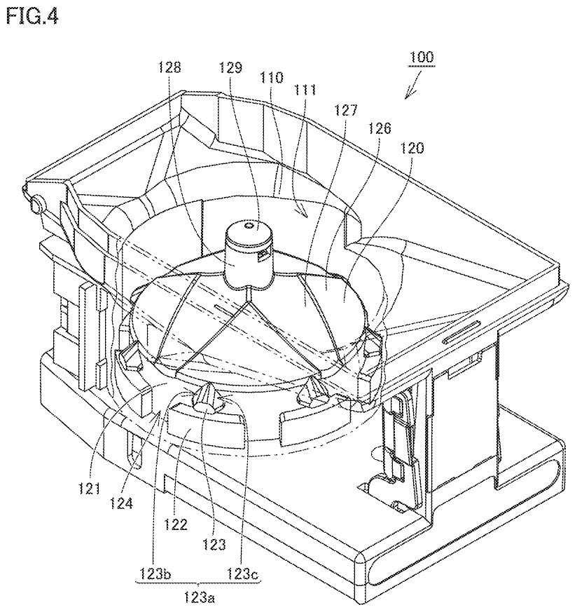

FIG. 1 is a perspective view showing a medicine supply device with an open lid according to a first embodiment of the present invention. FIG. 2 is a plan view of the medicine supply device in FIG. 1 as seen in a direction of an arrow II. FIG. 3 is a bottom view of the medicine supply device in FIG. 1 as seen in a direction of an arrow III. FIG. 4 is a perspective view showing the medicine supply device according to the first embodiment of the present invention, where a medicine containing portion is partially cut away. FIG. 5 is a perspective view showing the medicine supply device according to the first embodiment of the present invention, where a rotor is shown in see-through. FIGS. 4 and 5 show the medicine supply device with the lid removed. FIG. 5 indicates the rotor by dotted lines.

As shown in FIGS. 1 to 3, a medicine supply device 100 according to the first embodiment of the present invention includes a medicine containing portion 110, a rotor 120, a lid portion 130, and a partitioning portion 140. Medicine containing portion 110 has a circumferential wall 111 and a discharge port 112, and contains a medicine on an inner side of circumferential wall 111 and discharges the medicine through discharge port 112. Circumferential wall 111 has a cylindrical inner surface. Discharge port 112 is formed in a bottom surface of medicine containing portion 110, and is adjacent to the inner surface of circumferential wall 111 on a radially inner side of circumferential wall 111.

As shown in FIG. 3, in the bottom surface of medicine containing portion 110, a circular opening 113 is provided at the position of a central axis of circumferential wall 111. In opening 113, a connecting shaft portion 150 is inserted that connects rotor 120 to an output shaft of a not-shown motor that drives rotor 120 to rotate.

As shown in FIG. 1, lid portion 130 is pivotably provided to open and close medicine containing portion 110.

As shown in FIGS. 1 to 5, rotor 120 is rotatably disposed on the inner side of circumferential wall 111. Rotor 120 is disposed on the bottom surface of medicine containing portion 110. In the present embodiment, rotor 120 is configured to be capable of both forward rotation, which is a rotation to one side in a circumferential direction of rotor 120 as indicated by an arrow A in FIG. 2, and backward rotation, which is a rotation to the other side in the circumferential direction of rotor 120 as indicated by an arrow B in FIG. 2. Rotor 120 does not necessarily need to be capable of both the forward and backward rotations, and only needs to be capable of rotating to at least one side in the circumferential direction of rotor 120.

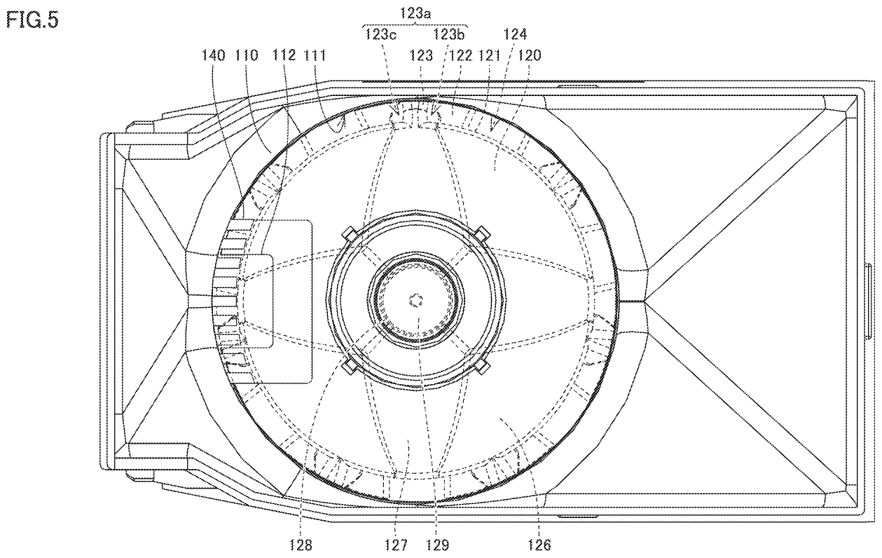

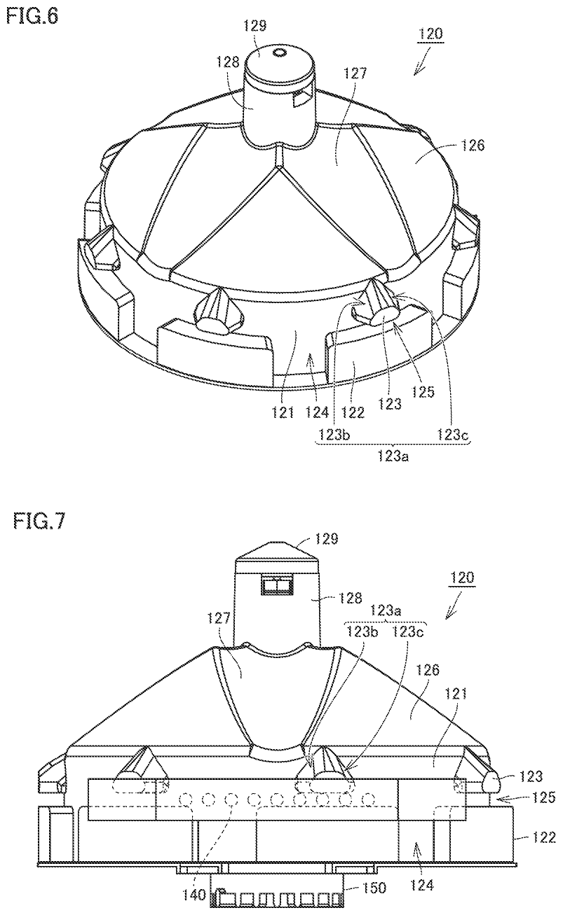

FIG. 6 is a perspective view showing an outer appearance of the rotor of the medicine supply device according to the first embodiment of the present invention. FIG. 7 is a side view showing a positional relationship between the rotor and the partitioning portion of the medicine supply device according to the first embodiment of the present invention. FIG. 7 shows a state where connecting shaft portion 150 is attached to rotor 120.

As shown in FIGS. 2 and 4 to 7, rotor 120 has an upwardly convexly inclined top surface 126, and a circumferential surface 121 adjacent to top surface 126. Top surface 126 is provided with a plurality of grooves 127 in a radial manner. A columnar portion 128 protrudes from a central portion of top surface 126. A cover 129 is removably attached to the upper end of columnar portion 128.

As shown in FIGS. 4, 6 and 7, at a lower portion of circumferential surface 121, a plurality of first protrusions 122 are provided and positioned with a gap 124 between them in the circumferential direction of rotor 120. Each of the plurality of first protrusions 122 has a substantially rectangular shape as seen in a radial direction of rotor 120. A tip end of each of the plurality of first protrusions 122 in the radial direction of rotor 120 faces the inner surface of circumferential wall 111 and is slightly spaced from the inner surface of circumferential wall 111.

Each of the plurality of first protrusions 122 is formed to be capable of, upon rotation of rotor 120, pressing a medicine contained in gap 124 and conveying the medicine to discharge port 112. Specifically, as rotor 120 rotates, the medicine contained in gap 124 is conveyed in the circumferential direction of rotor 120 while being pressed by first protrusions 122, and falls to discharge port 112.

At least two second protrusions 123 are further provided on circumferential surface 121. Specifically, one second protrusion 123 is disposed above each of at least two first protrusions 122 of the plurality of first protrusions 122. As shown in FIGS. 2 and 5, in the present embodiment, one second protrusion 123 is disposed above each of the plurality of first protrusions 122. A tip end of each of at least two second protrusions 123 faces the inner surface of circumferential wall 111 and is slightly spaced from the inner surface of circumferential wall 111.

As shown in FIG. 7, between first protrusion 122 and second protrusion 123 aligned in the vertical direction, a passage 125 through which partitioning portion 140 passes during rotation of rotor 120 is provided. In the vertical direction, passage 125 has a width dimension slightly larger than a thickness dimension of partitioning portion 140. Second protrusion 123 is formed to be capable of, upon rotation of rotor 120, pressing a medicine located on partitioning portion 140 and moving the medicine from over partitioning portion 140.

As shown in FIGS. 2 and 4 to 7, second protrusion 123 has, on one side in the circumferential direction of rotor 120, a one-side upper surface 123b inclined downward to one side in the circumferential direction of rotor 120.

In the present embodiment, second protrusion 123 further has, on the other side in the circumferential direction of rotor 120, an other-side upper surface 123c inclined downward to the other side in the circumferential direction of rotor 120. Second protrusion 123 does not necessarily need to have other-side upper surface 123c. In this case, one-side upper surface 123b may extend over the entire upper surface of second protrusion 123.

Second protrusion 123 has a horizontally positioned lower surface. In the present embodiment, second protrusion 123 has a triangular outer shape with rounded apexes as seen in the radial direction of rotor 120.

As shown in FIG. 7, in second protrusion 123, an upper surface 123a including one-side upper surface 123b and other-side upper surface 123c is inclined downward toward its tip end in a radial direction of circumferential surface 121. That is, second protrusion 123 has a tapered shape.

As shown in FIGS. 2 and 5, in the circumferential direction of rotor 120, an overall length of second protrusion 123 is shorter than an overall length of first protrusion 122. The overall length of second protrusion 123 refers to a length of second protrusion 123 at its longest point in the circumferential direction of rotor 120. Although a central position of first protrusion 122 and a central position of second protrusion 123 match each other in the circumferential direction of rotor 120 in the present embodiment, this is not limitative, and the central position of second protrusion 123 may be deviated from the central position of first protrusion 122.

As shown in FIGS. 2, 5 and 7, partitioning portion 140 is provided to extend from the inner surface of circumferential wall 111 toward circumferential surface 121 so as to partition between first protrusion 122 and second protrusion 123 above discharge port 112. Gap 124 in communication with discharge port 112 is covered with partitioning portion 140, so as to prevent entry of medicines from above.

In the present embodiment, partitioning portion 140 is formed of a flexible member. Specifically, as shown in FIGS. 5 and 7, partitioning portion 140 is formed by joining, to an arc-shaped base material, a plurality of flexible members spaced from each other along the arc. The base material forms part of circumferential wall 111. The flexible member is made of soft synthetic resin, for example. Although partitioning portion 140 is configured in the form of a brush in the present embodiment, it may be in the form of a plate without being limited to the form of a brush.

Operation of medicine supply device 100 according to the first embodiment of the present invention is now described.

As rotor 120 rotates with medicines put in medicine containing portion 110, the medicines located on top surface 126 move toward a space between the inner surface of circumferential wall 111 and circumferential surface 121 of rotor 120. As rotor 120 rotates, the plurality of grooves 127 shake the medicines located on top surface 126, to facilitate the movement of the medicines to the aforementioned space.

Some of the medicines that have moved to the aforementioned space are contained in gaps 124, such that one medicine is contained in each gap 124. As rotor 120 rotates, the medicines contained in gaps 124 are conveyed in the circumferential direction of rotor 120 while being pressed by first protrusions 122. A medicine contained in gap 124 located above and in communication with discharge port 112 falls to discharge port 112 from within gap 124 and is dispensed.

At this time, gap 124 in communication with discharge port 112 is covered with partitioning portion 140, so as to prevent entry of medicines from above. As a result, one medicine can be dispensed at a time through discharge port 112.

As rotor 120 rotates, medicines located on partitioning portion 140 are pressed by second protrusions 123 and moved from over partitioning portion 140. The medicines moved from over partitioning portion 140 are eventually contained in gaps 124 and conveyed to discharge port 112.

In the present embodiment, the forward rotation of rotor 120 causes a medicine to be dispensed through discharge port 112. When a medicine is not dispensed through discharge port 112 for a certain period of time during the forward rotation of rotor 120, rotor 120 repeats the backward rotation and the forward rotation. When a medicine is dispensed during the repeated backward rotation and forward rotation of rotor 120, rotor 120 performs the forward rotation again. When it is confirmed that a medicine has not been dispensed even after the backward rotation and the forward rotation of rotor 120 have been repeated multiple times, it is determined that all the medicines in medicine containing portion 110 have been discharged and no medicine is remaining in medicine containing portion 110, and rotor 120 stops.

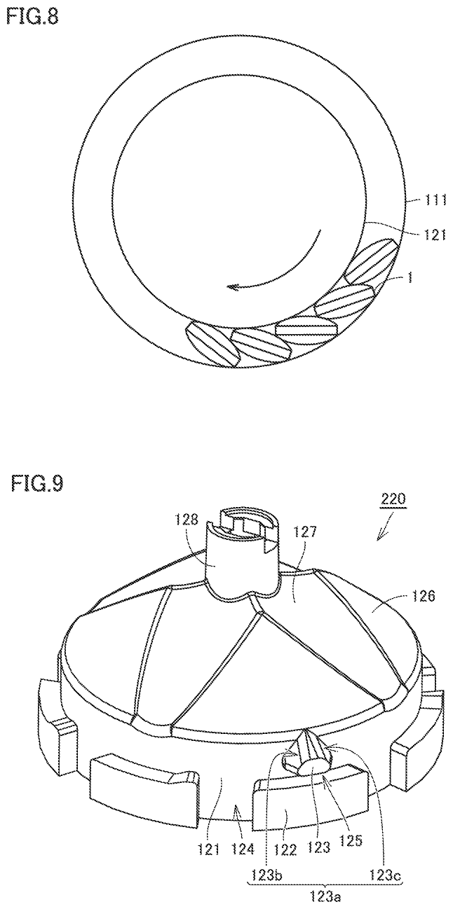

Here, sticking of medicines in medicine containing portion 110 is described. FIG. 8 is a plan view showing a state where sticking of medicines has occurred in the medicine containing portion. As shown in FIG. 8, when medicines 1 caught between circumferential wall 111 and circumferential surface 121 get stuck adjacent to each other in a rotational direction of the rotor indicated by an arrow, the rotor may stop.

In medicine supply device 100 according to the first embodiment of the present invention, as shown in FIGS. 2 and 4 to 7, second protrusion 123 has, on one side in the circumferential direction of rotor 120, one-side upper surface 123b inclined downward to one side in the circumferential direction of rotor 120.

Accordingly, if medicines 1 get caught between a portion of circumferential surface 121 that is above first protrusion 122 and the inner surface of circumferential wall 111, these caught medicines 1 can be pressed by one-side upper surface 123b with the forward rotation of rotor 120. Medicines 1 pressed by one-side upper surface 123b are picked up by second protrusion 123, to move out of the state of being caught between circumferential wall 111 and circumferential surface 121.

Since medicine supply device 100 has at least two second protrusions 123, medicines 1 caught between circumferential wall 111 and circumferential surface 121 can be released by at least two second protrusions 123 each time rotor 120 performs one rotation. Thus, sticking of medicines 1 in medicine containing portion 110 can be suppressed.

As described above, in medicine supply device 100 according to the first embodiment of the present invention, the occurrence of remaining medicines in medicine containing portion 110 can be prevented, and sticking of medicines 1 in medicine containing portion 110 can be suppressed.

In medicine supply device 100 according to the first embodiment of the present invention, second protrusion 123 further has, on the other side in the circumferential direction of rotor 120, other-side upper surface 123c inclined downward to the other side in the circumferential direction of rotor 120.

Accordingly, if medicines 1 get caught between the portion of circumferential surface 121 that is above first protrusion 122 and the inner surface of circumferential wall 111, these caught medicines 1 can be pressed by other-side upper surface 123c with the backward rotation of rotor 120. Medicines 1 pressed by other-side upper surface 123c are picked up by second protrusion 123, to move out of the state of being caught between circumferential wall 111 and circumferential surface 121. Therefore, sticking of medicines 1 in medicine containing portion 110 can be suppressed during both the forward rotation and the backward rotation of rotor 120.

In medicine supply device 100 according to the first embodiment of the present invention, the upper surface including one-side upper surface 123b and other-side upper surface 123c of second protrusion 123 is inclined downward toward its tip end in the radial direction of circumferential surface 121. Therefore, climbing of medicines 1 onto second protrusion 123 can be suppressed, and medicines 1 caught between circumferential wall 111 and circumferential surface 121 can be readily picked up, so that sticking of medicines 1 in medicine containing portion 110 can be effectively suppressed.

In medicine supply device 100 according to the first embodiment of the present invention, the overall length of second protrusion 123 is shorter than the overall length of first protrusion 122. Therefore, as compared to an example where second protrusion 123 has a similar shape to first protrusion 122, the volume of second protrusion 123 in medicine containing portion 110 can be reduced, to increase the number of medicines 1 contained in medicine containing portion 110.

In medicine supply device 100 according to the first embodiment of the present invention, partitioning portion 140 is formed of a flexible member. Therefore, a load applied to medicine 1 can be reduced when medicine 1 located on first protrusion 122 is pressed by second protrusion 123 and caught between second protrusion 123 and partitioning portion 140, to suppress damage to medicine 1.

### Second Embodiment

A medicine supply device according to a second embodiment of the present invention will be described hereinafter with reference to the drawings. As the medicine supply device according to the second embodiment of the present invention is different from medicine supply device 100 according to the first embodiment of the present invention in that the number of second protrusions is one, description of the configuration similar to that of medicine supply device 100 according to the first embodiment of the present invention will not be repeated.

FIG. 9 is a perspective view showing an outer appearance of a rotor of the medicine supply device according to the second embodiment of the present invention. FIG. 9 shows a state where cover 129 is removed.

One second protrusion 123 is provided on circumferential surface 121 of a rotor 220 of the medicine supply device according to the second embodiment of the present invention. As shown in FIG. 9, first protrusions 122 on which second protrusion 123 is not disposed may have a different shape than first protrusion 122 on which second protrusion 123 is disposed.

In the medicine supply device according to the second embodiment of the present invention, too, the occurrence of remaining medicines in medicine containing portion 110 can be prevented, and sticking of medicines 1 in medicine containing portion 110 can be suppressed. In addition, since the number of second protrusions 123 is one, the number of medicines 1 contained in medicine containing portion 110 can be increased, as compared to medicine supply device 100 according to the first embodiment in which one second protrusion 123 is disposed above each of the plurality of first protrusions 122.

### Third Embodiment

A medicine supply device according to a third embodiment of the present invention will be described hereinafter with reference to the drawings. As the medicine supply device according to the third embodiment of the present invention is different from medicine supply device 100 according to the first embodiment of the present invention in terms of the shape of the second protrusion, description of the configuration similar to that of medicine supply device 100 according to the first embodiment of the present invention will not be repeated.

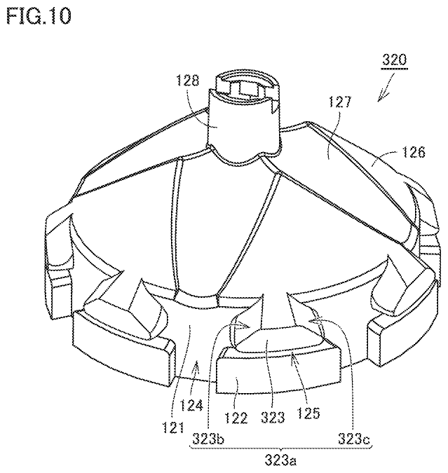

FIG. 10 is a perspective view showing an outer appearance of a rotor of the medicine supply device according to the third embodiment of the present invention. FIG. 10 shows a state where cover 129 is removed.

As shown in FIG. 10, at least two second protrusions 323 are provided on circumferential surface 121 of a rotor 320 of the medicine supply device according to the third embodiment of the present invention. Specifically, one second protrusion 323 is disposed above each of at least two first protrusions 122 of the plurality of first protrusions 122. As shown in FIG. 10, in the present embodiment, one second protrusion 323 is disposed above each of the plurality of first protrusions 122.

Between first protrusion 122 and second protrusion 323 aligned in the vertical direction, passage 125 through which partitioning portion 140 passes during rotation of rotor 320 is provided. In the vertical direction, passage 125 has a width dimension slightly larger than a thickness dimension of partitioning portion 140. Second protrusion 323 is formed to be capable of, upon rotation of rotor 320, pressing a medicine located on partitioning portion 140 and moving the medicine from over partitioning portion 140.

Second protrusion 323 has, on one side in a circumferential direction of rotor 320, a one-side upper surface 323b inclined downward to one side in the circumferential direction of rotor 320.

In the present embodiment, second protrusion 323 further has, on the other side in the circumferential direction of rotor 320, an other-side upper surface 323c inclined downward to the other side in the circumferential direction of rotor 320.

Second protrusion 323 has a horizontally positioned lower surface. In the present embodiment, second protrusion 323 has an isosceles trapezoidal shape with rounded apexes as seen in a radial direction of rotor 320.

In second protrusion 323, an upper surface 323a including one-side upper surface 323b and other-side upper surface 323c is inclined downward toward its tip end in the radial direction of circumferential surface 121. That is, second protrusion 323 has a tapered shape. A portion of an upper surface of second protrusion 323 that is located between one-side upper surface 323b and other-side upper surface 323c continues to top surface 126.

In the circumferential direction of rotor 320, an overall length of second protrusion 323 is shorter than the overall length of first protrusion 122. The overall length of second protrusion 323 refers to a length of second protrusion 323 at its longest point in the circumferential direction of rotor 320. The overall length of second protrusion 323 is longer than the overall length of second protrusion 123 according to the first embodiment.

In the medicine supply device according to the third embodiment of the present invention, too, the occurrence of remaining medicines in medicine containing portion 110 can be prevented, and sticking of medicines 1 in medicine containing portion 110 can be suppressed.

In addition, since the overall length of second protrusion 323 is longer than the overall length of second protrusion 123 according to the first embodiment, the inclination of each of one-side upper surface 323b and other-side upper surface 323c can be made more gentle. Therefore, the medicine supply device according to the third embodiment of the present invention can readily pick up medicines 1 caught between circumferential wall 111 and circumferential surface 121, as compared to medicine supply device 100 according to the first embodiment, to effectively suppress sticking of medicines 1 in medicine containing portion 110.

It should be noted that the embodiments disclosed herein are illustrative in every respect, and do not serve as a basis for restrictive interpretation. Therefore, the technical scope of the present invention is defined based on the terms of the claims, rather than interpreted based on the above embodiments only, and encompasses all modifications within the scope and meaning equivalent to the terms of the claims.

### REFERENCE SIGNS LIST

1 medicine; 100 medicine supply device; 110 medicine containing portion; 111 circumferential wall; 112 discharge port; 113 opening; 120, 220, 320 rotor; 121 circumferential surface; 122 first protrusion; 123, 323 second protrusion; 123a, 323a upper surface; 123b, 323b one-side upper surface; 123c, 323c other-side upper surface; 124 gap; 125 passage; 126 top surface; 127 groove; 128 columnar portion; 129 cover; 130 lid portion; 140 partitioning portion; 150 connecting shaft portion.

1. A medicine supply device comprising:
a medicine containing portion having a circumferential wall and a discharge port, the medicine containing portion containing a medicine on an inner side of the circumferential wall and discharging the medicine through the discharge port;
a rotor rotatably disposed on the inner side of the circumferential wall, the rotor having an upwardly convexly inclined top surface and a circumferential surface adjacent to the top surface;
a plurality of first protrusions provided on the circumferential surface and positioned with a gap between them in a circumferential direction of the rotor;
at least two second protrusions provided on the circumferential surface, each of the at least two second protrusions being disposed above each of at least two first protrusions of the plurality of first protrusions; and
a partitioning portion provided to extend from an inner surface of the circumferential wall toward the circumferential surface so as to partition between the at least two first protrusions and the at least two second protrusions above the discharge port, wherein
each of the plurality of first protrusions is formed to be capable of, upon rotation of the rotor, pressing a medicine contained in the gap and conveying the medicine to the discharge port,
each of the at least two second protrusions is formed to be capable of, upon rotation of the rotor, pressing a medicine located on the partitioning portion and moving the medicine from over the partitioning portion, and
each of the at least two second protrusions has, on one side in the circumferential direction, a one-side upper surface inclined downward to one side in the circumferential direction.

2. The medicine supply device according to claim 1, wherein
each of the at least two second protrusions further has, on the other side in the circumferential direction, an other-side upper surface inclined downward to the other side in the circumferential direction.

3. The medicine supply device according to claim 2, wherein
in each of the at least two second protrusions, an upper surface including the one-side upper surface and the other-side upper surface is inclined downward toward its tip end in a radial direction of the circumferential surface.

4. The medicine supply device according to claim 1, wherein
in the circumferential direction, an overall length of each of the at least two second protrusions is shorter than an overall length of each of the at least two first protrusions.

5. The medicine supply device according to claim 1, wherein
the partitioning portion is formed of a flexible member.

6. A medicine supply device comprising:
a medicine containing portion having a circumferential wall and a discharge port, the medicine containing portion containing a medicine on an inner side of the circumferential wall and discharging the medicine through the discharge port;
a rotor rotatably disposed on the inner side of the circumferential wall, the rotor having an upwardly convexly inclined top surface and a circumferential surface adjacent to the top surface;
a plurality of first protrusions provided on the circumferential surface and positioned with a gap between them in a circumferential direction of the rotor;
one second protrusion provided on the circumferential surface and disposed above one first protrusion of the plurality of first protrusions; and
a partitioning portion provided to extend from an inner surface of the circumferential wall toward the circumferential surface so as to partition between the one first protrusion and the one second protrusion above the discharge port, wherein
each of the plurality of first protrusions is formed to be capable of, upon rotation of the rotor, pressing a medicine contained in the gap and conveying the medicine to the discharge port,
the one second protrusion is formed to be capable of, upon rotation of the rotor, pressing a medicine located on the partitioning portion and moving the medicine from over the partitioning portion, and
the one second protrusion has, on one side in the circumferential direction, a one-side upper surface inclined downward to one side in the circumferential direction.
